(19) United States
(12) Patent Application Publication
(10) Pub. No.: US 2018/0087404 A1
(43) Pub. Date: Mar. 29, 2018

(54) OIL DISTRIBUTOR

(71) Applicant: Rolls-Royce Corporation, Indianapolis, IN (US)

(72) Inventor: Kerry J. Lighty, Plainfield, IN (US)

(73) Assignee: Rolls-Royce Corporation, Indianapolis, IN (US)

(21) Appl. No.: 15/274,405

(22) Filed: Sep. 23, 2016

(51) Int. Cl. F01D 25/18; F01D 11/00

(52) U.S. Cl. CPC F01D 25/183; F01D 11/003; F05D 2260/232; F05D 2240/60; F05D 2220/30

(57) ABSTRACT

Systems and methods of providing oil for lubrication and/or cooling to an engine component in a turbine engine. A system for directing oil flow across a radially inward facing surface of the engine component comprises a nozzle axially forward of the component which is configured to eject a stream of oil, a deflecting body having a deflecting surface positioned to receive the stream of oil incident thereon and configured to deflect the stream of oil axially rearward, and an oil catcher comprising an annular catching flange positioned to receive the deflected stream of oil incident thereon and defining a plurality of grooves configured to channel the incident oil axially rearward to the component.

### FIELD OF THE DISCLOSURE

The present disclosure relates generally to lubrication and cooling systems, and more specifically to an oil distributor circumferentially disposed about a rotatable shaft of a turbine engine.

### BACKGROUND

Turbine engines provide energy for a wide range of uses. A typical turbine engine comprises a compressor, a combustor, a high-pressure turbine, and a low-pressure turbine. Compressor and turbine blades are typically coupled to rotor discs, and these rotor discs are coupled to at least one rotatable shaft. During operation of the turbine engine, the rotatable shaft rotates at high rates of speed and is supported by various bearings disposed along the length of the rotor shaft. Sealing members may also be circumferentially disposed about the rotatable shaft in order to segregate certain regions surrounding the rotatable shaft.

The bearings and seal members generally require lubrication and cooling, each of which can be provided by supplying oil to the bearing or seal member. However, oil can be difficult to supply given the space constraints encountered in a turbine engine. Oil pathways must be provided which will adequately lubricate and cool the bearings and seal members, but which accommodate other components in the crowded turbine engine environment. In confined areas with limited axial and/or radial space around the rotatable shaft, oil must be supplied in a sufficient volume to lubricate and cool the bearings and seal members.

To meet this need for lubrication and cooling, previous efforts in the field have developed systems and methods of delivering a stream or jet of oil directly to a component, as illustrated in FIG. 1. A seal member 102 requiring lubrication or cooling is coupled to the rotatable shaft 104. An oil stream 106 is ejected from a nozzle 108 of a nozzle assembly 110. The oil stream 106 is directed toward and contacts the seal member 102, thus providing lubrication and cooling to the seal member 102.

However, in environments which are more axially constrained than that depicted in FIG. 1, the direct application of an oil stream to a seal member may not be possible. It is therefore desirable to develop systems and methods of delivering oil to bearings and seal members in axially-constrained engine environments.

### SUMMARY

The present application discloses one or more of the features recited in the appended claims and/or the following features which, alone or in any combination, may comprise patentable subject matter.

According to an aspect of the present disclosure, a system is presented for directing oil flow across a radially inward facing surface of a sealing flange. The system is disposed in a turbine engine having a rotatable shaft and a metallic seal runner coupled to the shaft. The seal runner comprises a coupling flange coupled to the shaft, a radially extending flange extending radially outward from the coupling flange, and an annular sealing flange extending axially forward from the radially extending flange. The sealing flange has a radially inward facing surface spaced radially outward from the shaft.

The system comprises a nozzle positioned axially forward of the seal runner and spaced radially outward from the shaft, the nozzle being configured to eject a stream of oil under pressure toward the shaft; a deflecting body coupled to the shaft axially forward of the seal runner, the deflecting body having a deflecting surface positioned to receive the stream of oil incident thereon and configured to deflect the stream of oil axially rearward; and an oil catcher comprising an annular catching flange positioned intermediate the sealing flange and the shaft, the catching flange having a radially inward facing surface positioned to receive the deflected stream of oil incident thereon and defining a plurality of grooves configured to channel the incident oil axially rearward during rotation of the shaft to thereby deliver the oil to the radially inward facing surface of the sealing flange.

In some embodiments the radially inward facing surface of the sealing flange defines an annular channel at a junction between the sealing flange and the radially extending flange, the catching flange of the oil catcher being positioned to deliver oil to the annular channel. In some embodiments the deflecting surface is conical. In some embodiments the stream of oil is incident on the deflecting body at a location laterally displaced from the axis of rotation of the shaft. In some embodiments the deflecting body is rotating away from the stream of oil at the location of incidence. In some embodiments the oil catcher comprises an oil retention lip extending radially inward from an axially forward end of the catching flange.

In some embodiments the plurality of grooves are parallel to the axis of rotation of the shaft. In some embodiments the plurality of grooves are angled relative to the axis of rotation of the shaft. In some embodiments the deflecting body has a radially extending wall configured to direct oil into the catching flange. In some embodiments the plurality of grooves are formed as channels with curved sides passing axially through the catcher. In some embodiments the plurality of grooves are formed as rounded holes passing axially through the catcher. In some embodiments the sealing flange has a radially outward facing surface which contacts a sealing assembly. In some embodiments the system further comprises an oil sump collection point configured to collect oil which has been delivered to the radially inward facing surface of the sealing flange. In some embodiments the oil sump collection point is in fluid communication with the nozzle.

According to another aspect of the present disclosure, a method of cooling an annular metallic seal runner coupled to rotating shaft in a turbine engine comprises supplying an oil stream ejected from a nozzle toward the rotating shaft; deflecting an incident oil stream by a conical deflecting surface coupled to the rotating shaft; catching the deflected oil stream on an annular oil catcher positioned intermediate the seal runner and the shaft; directing the oil caught by the oil catcher by centrifugal force through a plurality of channels axially rearward to a radially inward facing surface of the seal runner; and directing the oil by centrifugal force axially forward across the radially inward facing surface of the seal runner.

In some embodiments the oil stream is angled both axially and laterally relative to the shaft. In some embodiments the method further comprises pooling the oil in an annular reservoir defined by the radially inner surface of the seal runner. In some embodiments the method further comprises providing an oil retention lip on an axially forward end of the oil catcher and selecting the angle of incidence of the oil stream on the deflecting surface and the angle of deflection of the oil stream from the deflecting surface to thereby catch the deflected oil on the oil catcher axially aft of the oil retention lip. In some embodiments the method further comprises collecting oil in a sump collecting point. In some embodiments the conical deflecting surface is rotating away from the stream of oil at a location of incidence.

### BRIEF DESCRIPTION OF THE DRAWINGS

The following will be apparent from elements of the figures, which are provided for illustrative purposes and are not necessarily to scale.

FIG. 1 is a side cutaway view of a nozzle assembly directly applying an oil stream to a seal member.

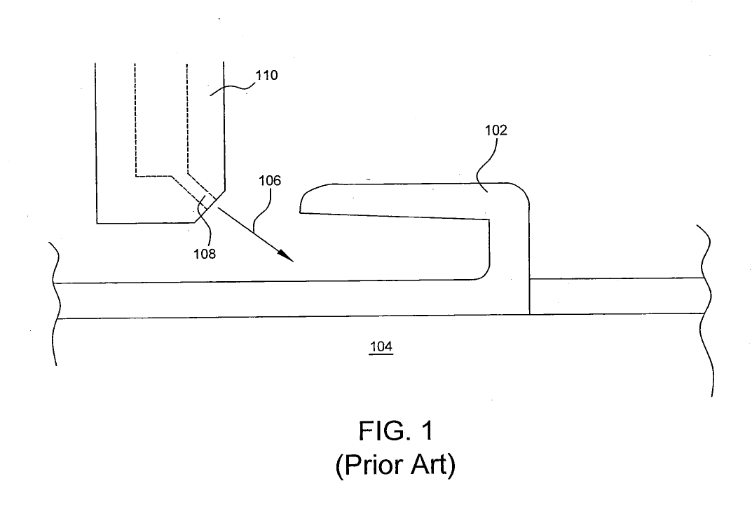

FIG. 2A is a side cutaway view of an oil distributor in accordance with some embodiments of the present disclosure.

FIG. 2B is an enlarged side cutaway view of an oil distributor in accordance with some embodiments of the present disclosure.

FIG. 2C is an enlarged side cutaway view of an oil distributor showing an oil pathway in accordance with some embodiments of the present disclosure.

FIG. 3A is a profile view of the axially aft end of an oil distributor in accordance with some embodiments of the present disclosure.

FIG. 3B is a profile view of the axially aft end of an oil distributor in accordance with some embodiments of the present disclosure.

FIG. 3C is a profile view of the axially aft end of an oil distributor in accordance with some embodiments of the present disclosure.

FIG. 4 is a flow chart of a method in accordance with some embodiments of the present disclosure.

FIG. 5 is an axial cutaway view of an oil distributor, nozzle, and oil stream in accordance with some embodiments of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

For the purposes of promoting an understanding of the principles of the disclosure, reference will now be made to a number of illustrative embodiments illustrated in the drawings and specific language will be used to describe the same.

This disclosure presents systems and methods of providing lubrication and cooling to an engine component in an axially constrained environment which overcomes the deficiencies noted above. More specifically, the present disclosure is directed to an oil distributor configured to receive an oil stream traveling substantially in a radially inward direction, re-direct the oil to substantially axial motion, and deliver the oil to an engine component requiring lubrication and/or cooling such as a bearing, seal runner, or seal member.

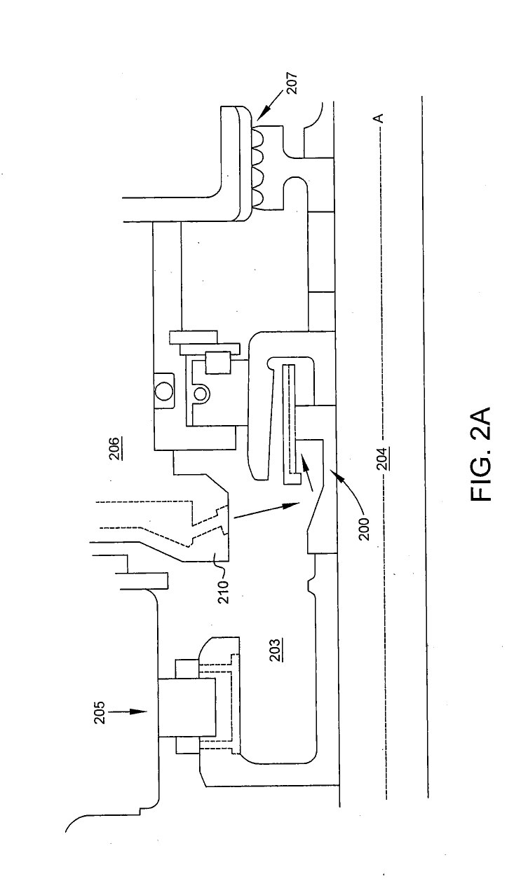

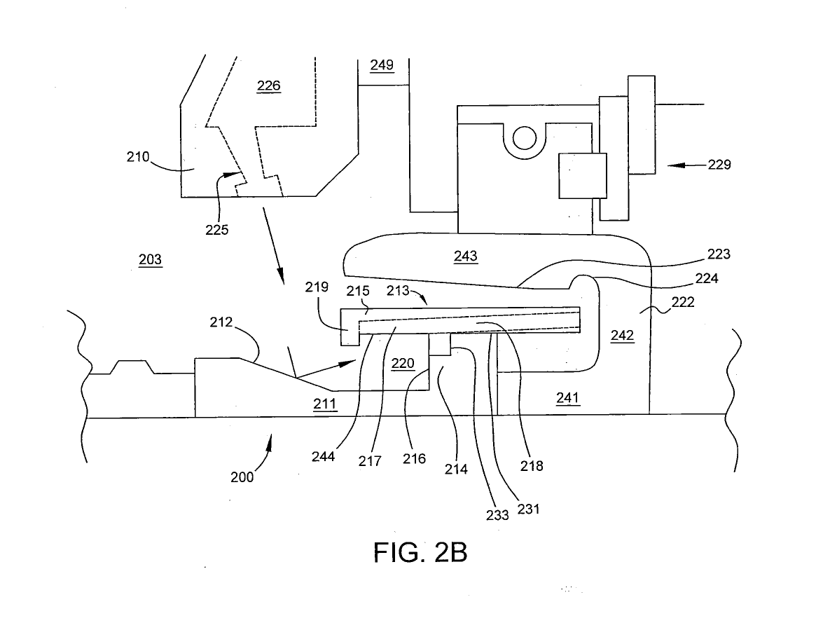

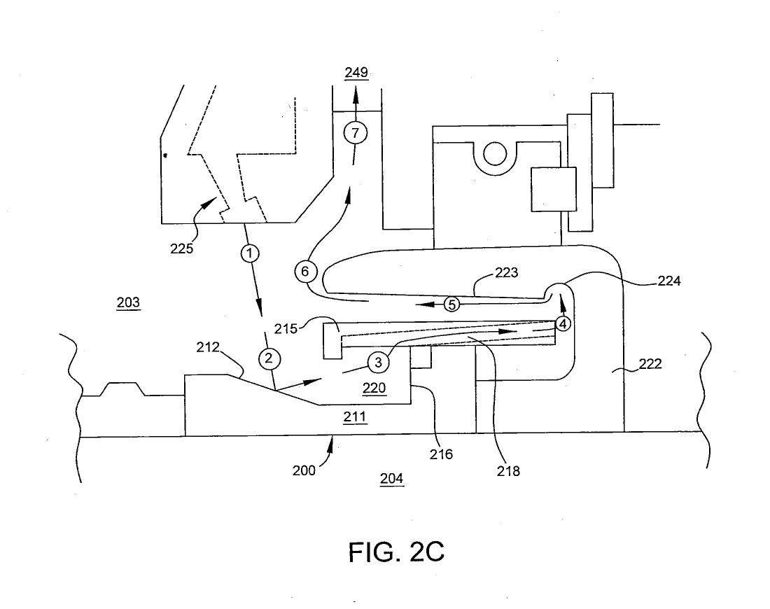

FIGS. 2A, 2B, and 2C present side cutaway view of an oil distributor 200 in accordance with some embodiments of the present disclosure. The oil distributor 200 is coupled to a rotatable shaft 204 and is therefore disposed in a sealed environment 203 surrounding the rotatable shaft 204. In the illustrated embodiment, the sealed environment 203 is an HP-LP sump of a turbine engine. Shaft 204 is rotatable about an axis of rotation A.

In the illustrated embodiment, oil distributor 200 is disposed axially between a bearing element 205 and labyrinth seal 207, and is radially disposed between shaft 204 and outer sump wall 206. Oil distributor 200 is disposed radially inward from a nozzle assembly 210 which forms a portion of the outer sump wall 206. Oil distributor 200 is further disposed at least partially radially inward from the inner surface 223 of a seal runner 222 which may be an annular component.

Oil distributor 200 comprises a deflecting body 211 positioned axially forward of seal runner 222. Deflecting body 211 has a deflecting surface 212 and a catcher 213. Deflecting surface 212 is disposed in line with an oil stream from a nozzle assembly and configured to deflect the oil stream toward the catcher 213. Deflecting surface 212 positioned to receive the stream of oil incident thereon and configured to deflect the stream of oil axially rearward.

Catcher 213 comprises and an axially extending catching flange 215, which in some embodiments includes a retention lip 219. Catcher 213 and/or catching flange 215 may be positioned intermediate the sealing flange 243 of seal runner 222 and the shaft 204. Catching flange 215 has a radially inward facing surface 244 positioned to receive deflected oil from the deflecting surface 212.

Catcher 213 may be coupled to the deflecting body 211 by a radially extending member 214. An axially facing surface of the radially extending member 214 forms an axial limit 216, which directs all deflected oil in a radially outward direction and onto the catching flange 215. Retention lip 219 extends radially inward from an axially forward end of the catching flange 215.

In some embodiments, deflecting surface 212 is conical or conically shaped. In some embodiments, deflecting surface 212 is shaped as a conical frustum. Deflecting surface 212 may be angled to receive an oil stream from nozzle assembly 210 and direct it toward one or more of catching flange 215, inlet plenum 220, and/or axial limit 216.

Catching flange 215 defines a receiving reservoir 217, which is in fluid communication with at least one groove 218 which passes axially through the catching flange 215. Grooves 218 are configured to channel the incident oil axially rearward during rotation of the shaft 204 to thereby deliver the oil to the radially inward facing surface 223 of the sealing flange 243. In some embodiments, grooves 218 may be parallel to an axis of rotation A. In other embodiments, grooves 218 may be angled relative to the axis of rotation A such that oil in the groove 218, under the influence of centrifugal forces caused by the rotation of the shaft 204 and oil distributor 200, will migrate axially along the groove 218. In other words, one axial terminus of the groove 218 may be disposed at a greater radial distance from the shaft 204 or the axis of rotation A than another axial terminus of the groove 218. In some embodiments a plurality of grooves 218 are defined by the catching flange 215 and each convey oil axially. In some embodiments the plurality of grooves 218 are formed as grooves in the catching flange 215.

In some embodiments, catching flange 215 includes a retention lip 219. Retention lip 219 serves to block the axially forward movement of oil out of the inlet plenum 220, which would be oil lost to the collection point 249 described below. Lost oil results in a decreased efficiency of the oil distributor 200. Retention lip 219 is configured to prevent oil from exiting the inlet plenum 220 in an axially forward direction and to direct oil into a groove 218 of the oil distributor 200.

Catcher 213, member 214, and deflecting body 211 together define an inlet plenum 220 which receives deflected oil from deflecting surface 212.

In some embodiments, catcher 213 and deflecting body 211 are formed separately and joined to form oil distributor 200. Catcher 213 and deflecting body 211 may be joined at junction 231, which shows an axial stop 233 that aids in correctly positioning the catcher 213 to the deflecting body 211 in the axial direction.

In the illustrated embodiment, oil distributor 200 is configured to direct oil onto a seal runner 222. In other embodiments, oil distributor 200 may be positioned and/or configured to direct oil to a bearing, a seal, a seal member, or other components of the turbine engine requiring lubrication and/or cooling. Seal runner 222 is disposed radially outward from at least one end of groove 218 such that oil exiting the groove 218 flows onto the seal runner 222.

Seal runner 222 comprises a coupling flange 241, a radially-extending flange 242, and an annular sealing flange 243. Coupling flange 241 is coupled to shaft 204. Radially-extending flange 242 extends radially outward from coupling flange 241. Annular sealing flange 243 extends axially forward from radially extending flange 242 and includes a radially inward facing surface 223. The radially inward facing surface 223 is thus radially spaced from the shaft 204 and coupling flange 241.

To properly cool seal runner 222, oil flow must be directed across the surface 223. Seal runner 222 radially interfaces with a seal assembly 229. In some embodiments a fluid film develops between seal runner 222 and seal assembly 229 during operation of the engine. In some embodiments seal runner 222 is metallic.

In some embodiments an annular reservoir 224 or channel is defined by surface 223 and configured to hold oil such that when reservoir 224 is full, oil overflows the reservoir 224 and flows along the surface 223 under the influence of centrifugal forces. Annular reservoir 224 is configured to ensure an evenly distributed oil flow around the full circumference of the surface 223 of seal runner 222. In some embodiments annular reservoir 224 may be formed at the junction between the sealing flange 243 and the radially-extending flange 242.

In some embodiments surface 223 is disposed at an angle relative to the axis of rotation or relative to shaft 204, such that oil flowing under the influence of centrifugal forces will flow axially along the surface 223. In other words, in some embodiments one end of surface 223 may be at a greater radial distance from shaft 204 than another end.

Nozzle assembly 210 comprises a nozzle 225 and oil chamber 226.

Oil is pressurized and ejected from nozzle 225 in a radially inward direction. Oil must be ejected at a rate of speed sufficient to overcome centrifugal forces and still reach the oil distributor 200. In some embodiments nozzle assembly 210 is positioned axially forward of seal runner 222. In some embodiments nozzle assembly 210 may be spaced radially outward from the shaft 204.

In some embodiments, the oil stream is perpendicular to the axis of rotation A. In other embodiments, the oil stream is angled relative to a plane perpendicular to the axis of rotation A. In some embodiments, the oil stream may be angled relative to the axis of rotation A and relative to a plane perpendicular to the axis of rotation A. Aligning the oil stream with the rotation of the shaft 204 will reduce the tendency of the oil to break up and generate mist upon impact with deflecting surface 212.

A collection point 249 may be disposed axially forward and radially outward from the seal runner 222 and configured to collect oil from the sealed environment 203. In some embodiments, the collection point 249 is disposed in the most radially outward potion of the sealed environment 203. In some embodiments, the collection point 249 is disposed at the bottom or lowest point of the sealed environment 203 such that gravity assists in moving the oil to the collection point 249. Collection point 249 may be in fluid communication with a collection tank, reservoir, holding chamber, oil pump, or similar component.

In some embodiments, deflecting body 211, member 214, and catcher 213 are formed as a unitary component or manufactured from a single material. In other embodiments, catcher 213 may be manufactured separately and interference fit or otherwise attached to member 214. In such embodiments, catcher 213 may be axially positioned to ensure proper flow of oil from grooves 218 to the seal runner 222. Manufacturing the oil distributor 200 may require a combination of turning or lathe operations, milling, and/or drilling. The catcher 213 may be attached to member 214 by interference fitting, brazing, welding, adhering, retaining ring, pins, or other fasteners.

The operation of the oil distributor 200 is best illustrated in FIG. 2C, which shows the flowpaths of oil with numbered arrows. An oil stream, illustrated as Arrow 1, is ejected from nozzle 225 at a sufficient rate of speed to overcome centrifugal forces and reach an oil distributor 200. The oil stream impacts a deflecting surface 212 of the oil distributor 200 and is deflected from a substantially radially inward direction to a radially outward and axially aft direction. The deflection of the oil stream is illustrated as Arrow 2.

Based on the deflection of the oil stream from the deflecting surface 212, oil enters the inlet plenum 220 which is partially defined by a catcher 213 and deflecting body 211 of the oil distributor 200. An axial limit 216, which is a radially-extending surface of the oil distributor 200, prevents excessive motion of the oil in an axially aft direction and directs the oil in a radially outward direction toward catcher 213. As indicated by Arrow 3, oil in the inlet plenum 220 is pushed radially outward by centrifugal forces and thus contacts the catching flange 215 of catcher 213. The oil contacting the catching flange 215 is then moved axially into one of a plurality of grooves 218. As described above, grooves 218 may be angled relative to the axis of rotation A such that oil moves axially aft under the influence of centrifugal forces. In other embodiments, grooves 218 may be parallel to the axis of rotation A, wherein the oil is moved axially aft because axial forward movement is prevented by the retention lip 219. Oil collecting at receiving reservoir 217 and against retention lip 219 will migrate axially aft.

As shown by Arrow 4, oil exiting a groove 218 is moved radially outward by centrifugal forces and contacts seal runner 222. In some embodiments the oil enters an annular reservoir 224 of the seal runner 222. Once sufficient oil has built up in the reservoir 224, additional oil entering the reservoir 224 will overtop the reservoir 224 and flow along the radially inner surface 223 of seal runner 222, as illustrated by Arrow 5. Surface 223 may be angled relative to the axis of rotation A such that oil moves axially when under the influence of centrifugal forces.

Once the oil has flowed along the axial length of surface 223, it will be moved radially outward by centrifugal forces toward the collection point 249 of the sealed environment 203. This movement and collection of the oil is illustrated as Arrows 6 and 7.

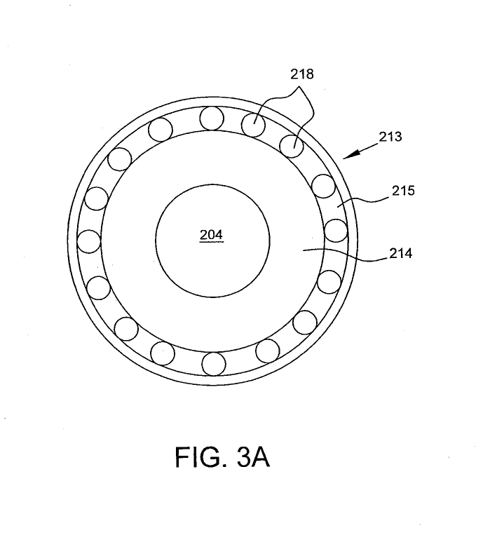

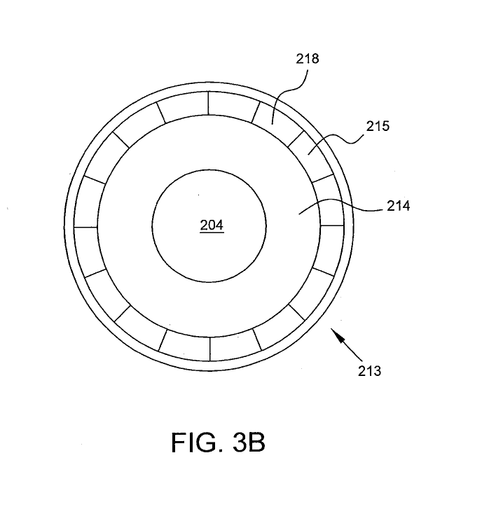

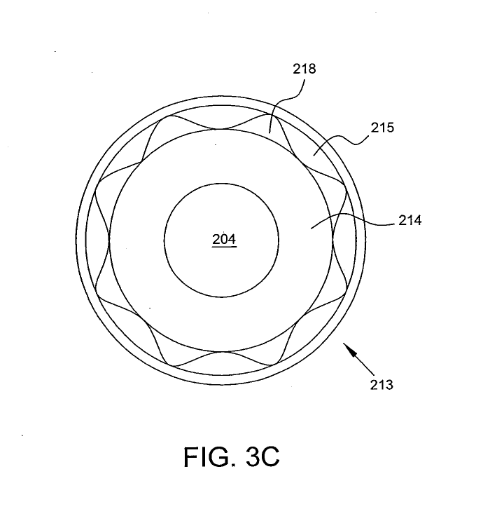

FIGS. 3A, 3B, and 3C are profile views of the axially aft end of an oil distributor 200 which illustrate various groove 218 geometries which may be used on catcher 213. As seen in FIGS. 3A, 3B, and 3C, a plurality of grooves 218 may be defined by the catcher 213 and spaced circumferentially around the shaft 204. Grooves 218 may be radially spaced from the shaft 204 or deflecting body 211 by radially extending member 214. Oil exiting from the illustrated axially aft end of the oil distributor 200 is directed onto the seal runner 222.

FIG. 3A illustrates an embodiment wherein the plurality of grooves 218 may be drilled or otherwise formed as holes through catcher 213. FIG. 3B illustrates an embodiment wherein the plurality of grooves 218 may be milled or otherwise formed as straight sided channels through catcher 213. FIG. 3C illustrates an embodiment wherein the plurality of grooves 218 may be milled or otherwise formed as channels having curved sides through catcher 213, thus forming a scalloped pattern. Additional groove 218 geometries are contemplated.

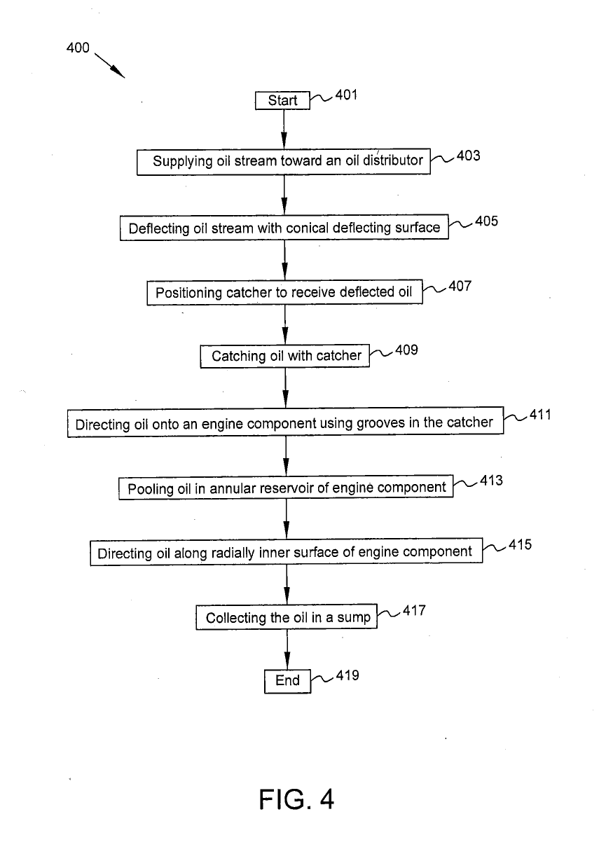

The present disclosure further provides a method 400 of cooling or lubricating an engine component, which may be a seal runner 222. The method 400 is presented in the flow chart of FIG. 4. The method 400 starts at block 401. At block 403 an oil stream is supplied in the direction of an oil distributor 200. In some embodiments the oil stream is supplied from the nozzle 225 of a nozzle assembly 210. The oil stream impacts a deflecting surface 212 of the oil distributor 200 and is deflected at block 405. In some embodiments the deflecting surface 212 is conical or shaped as a conical frustum. The oil may be deflected from a substantially radially inward direction to a radially outward and axially aft direction.

At block 407 a catcher 213 is positioned to receive or capture the deflected oil. The catcher 213 may be positioned prior to the step of supplying the oil stream at block 401. At block 409 the oil is caught by the catcher 213, and at block 411 the oil is directed onto the engine component via grooves 218. In some embodiments grooves 218 are grooved channels milled into the catching flange 215. In some embodiments grooves 218 are angled relative to the axis of rotation A such that oil in the grooves 218 under influence of centrifugal forces will move axially. Oil exiting the grooves 218 is forced radially outward and onto an engine component which requires lubrication and/or cooling.

In some embodiments the oil is pooled in a reservoir 224 defined by the engine component (block 413). The reservoir 224 is configured to ensure an evenly distributed flow of oil across the engine component. At block 415, oil is directed over a radially inner surface 223 of the engine component. In some embodiments, the radially inner surface 223 is angled relative to an axis of rotation A such that that oil contacting the surface 223 under the influence of centrifugal forces will move axially.

Once the oil has traveled the axial length of surface 223, it releases contact with the engine component and enters an oil sump. Oil may be collected through an oil sump collection point 249, as indicated at block 417. The method 400 ends at block 419.

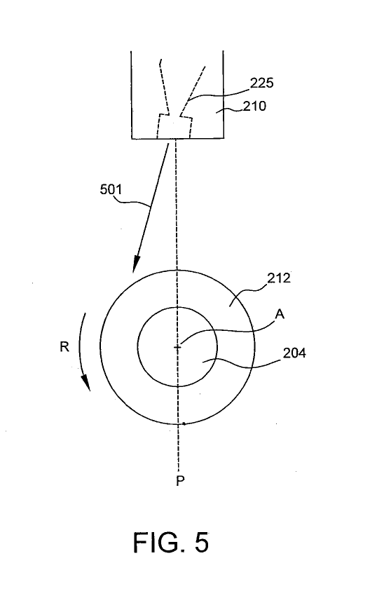

FIG. 5 provides an axial cutaway view of an oil distributor 200, nozzle assembly 210, and oil stream 501. As shown in FIG. 5, in some embodiments the oil stream 501 may be angled with the direction of rotation R of the rotatable shaft 204. In other words, the oil stream 501 may be angled relative to a plane P which is parallel to or intersects the axis of rotation. By laterally angling the oil stream 501 as shown in FIG. 5, the impact of the oil stream on deflecting surface 212 is less likely to produce an oil mist, which can result in increased oil losses from the catcher 213 and thus decreased efficiency of the oil distributor 200.

In some embodiments the stream of oil is incident on the deflecting body 211 at a location laterally displaced from the axis of rotation A of shaft 204. In some embodiments the deflecting body 211 and shaft 204 are rotating away from the stream of oil at the location of incidence.

The present disclosure advantageously provides systems and methods for lubricating engine components in a constrained axial space environment. The axial space needed for the disclosed system is less than prior art systems because an oil stream is deflected from substantially radial motion to substantially axial motion. The deflected oil is then collected by a catching flange and directed onto an engine component requiring lubrication and/or cooling by axially running grooves. The disclosed oil distributor is simpler and less costly to manufacture than more complex geometries.

Although the present disclosure uses the term “oil” to describe the disclosed systems and methods, it would be understood to one of ordinary skill in the art that the disclosed oil distributor, system of oil distribution, and methods of oil distribution could be used to distribute other fluids as well, and that the present disclosure is therefore not limited solely to oil distribution.

Although examples are illustrated and described herein, embodiments are nevertheless not limited to the details shown, since various modifications and structural changes may be made therein by those of ordinary skill within the scope and range of equivalents of the claims.

What is claimed is:

1. In a turbine engine having a rotatable shaft and a metallic seal runner coupled to said shaft, said seal runner comprising a coupling flange coupled to said shaft, a radially extending flange extending radially outward from said coupling flange, and an annular sealing flange extending axially forward from said radially extending flange, said sealing flange having a radially inward facing surface spaced radially outward from said shaft,
a system for directing oil flow across said radially inward facing surface of said sealing flange, said system comprising:
a nozzle positioned axially forward of said seal runner and spaced radially outward from said shaft, said nozzle being configured to eject a stream of oil under pressure toward said shaft;
a deflecting body coupled to said shaft axially forward of said seal runner, said deflecting body having a deflecting surface positioned to receive the stream of oil incident thereon and configured to deflect the stream of oil axially rearward; and
an oil catcher comprising an annular catching flange positioned intermediate said sealing flange and said shaft, said catching flange having a radially inward facing surface positioned to receive the deflected stream of oil incident thereon and defining a plurality of grooves configured to channel the incident oil axially rearward during rotation of said shaft to thereby deliver the oil to said radially inward facing surface of said sealing flange.

2. The system of claim 1 wherein said radially inward facing surface of said sealing flange defines an annular channel at a junction between said sealing flange and said radially extending flange, said catching flange of said oil catcher being positioned to deliver oil to said annular channel.

3. The system of claim 1 wherein said deflecting surface is conical.

4. The system of claim 1 wherein the stream of oil is incident on said deflecting body at a location laterally displaced from the axis of rotation of said shaft.

5. The system of claim 4 wherein said deflecting body is rotating away from the stream of oil at the location of incidence.

6. The system of claim 1 wherein said oil catcher comprises an oil retention lip extending radially inward from an axially forward end of said catching flange.

7. The system of claim 1 wherein said plurality of grooves are parallel to the axis of rotation of said shaft.

8. The system of claim 1 wherein said plurality of grooves are angled relative to the axis of rotation of said shaft.

9. The system of claim 1 wherein said deflecting body has a radially extending wall configured to direct oil into said catching flange.

10. The system of claim 1 wherein said plurality of grooves are formed as channels with curved sides passing axially through said catcher.

11. The system of claim 1 wherein said plurality of grooves are formed as rounded holes passing axially through said catcher.

12. The system of claim 1 wherein said sealing flange has a radially outward facing surface which contacts a sealing assembly.

13. The system of claim 1 further comprising an oil sump collection point configured to collect oil which has been delivered to said radially inward facing surface of said sealing flange.

14. The system of claim 13 wherein said oil sump collection point is in fluid communication with said nozzle.

15. A method of cooling an annular metallic seal runner coupled to rotating shaft in a turbine engine, the method comprising:
supplying an oil stream ejected from a nozzle toward the rotating shaft;
deflecting an incident oil stream by a conical deflecting surface coupled to the rotating shaft;
catching the deflected oil stream on an annular oil catcher positioned intermediate the seal runner and the shaft;
directing the oil caught by the oil catcher by centrifugal force through a plurality of channels axially rearward to a radially inward facing surface of the seal runner; and
directing the oil by centrifugal force axially forward across the radially inward facing surface of the seal runner.

16. The method of claim 15 wherein the oil stream is angled both axially and laterally relative to the shaft.

17. The method of claim 15 further comprising pooling the oil in an annular reservoir defined by the radially inner surface of the seal runner.

18. The method of claim 15 comprising providing an oil retention lip on an axially forward end of the oil catcher and selecting the angle of incidence of the oil stream on the deflecting surface and the angle of deflection of the oil stream from the deflecting surface to thereby catch the deflected oil on the oil catcher axially aft of the oil retention lip.

19. The method of claim 15 further comprising collecting oil in a sump collecting point.

20. The method of claim 16 wherein said conical deflecting surface is rotating away from the stream of oil at a location of incidence.
